(19) United States
(12) Patent Application Publication
(10) Pub. No.: US 2005/0240468 A1
(43) Pub. Date: Oct. 27, 2005

(54) Method and apparatus for population segmentation

(75) Inventors: Kenneth L. Inman, Poway, CA (US); David R. Miller, Annandale, VA (US)

Correspondence Address: DUCKOR SPRADLING METZGER, 401 WEST A STREET, SUITE 2400, SAN DIEGO, CA, 92101-7915, US

(73) Assignee: Claritas, Inc.

(21) Appl. No.: 11/119,235

(22) Filed: Apr. 29, 2005

Related U.S. Application Data
(63) Continuation-in-part of application No. 10/829,405, filed on Apr. 21, 2004.

(51) Int. Cl. G06F 17/60

(52) U.S. Cl. 705/10

(57) ABSTRACT

A method and system are disclosed for segmenting a population, and include the defining of a base level population segmentation tree. A set of alternative level variables usable as substitutes in the nodes of the population segmentation tree are defined. Substitute split values for each node of the tree are determined to enable up and down shifting between levels.

### RELATED APPLICATION

This application is a continuation in part patent application of U.S. patent application, application Ser. No. 10/829,405, filed Apr. 21, 2004, and entitled METHOD AND APPARATUS FOR POPULATION SEGMENTATION.

### FIELD OF THE INVENTION

The present invention relates in general to method and apparatus for population segmentation. The invention relates more specifically to method and apparatus which may be used for multiple segmentation levels such as household levels, geographic levels and others.

### BACKGROUND ART

For marketing purposes, knowledge of customer behavior is important, if not crucial. For direct marketing, for example, it is desirable to focus the marketing on a portion of the segment likely to purchase the marketed product or service.

In this regard, several methods have traditionally been used to divide the customer population into segments. The goal of such segmentation methods is to predict consumer behavior and classify consumers into clusters based on observable characteristics. Factors used to segment the population into clusters include demographic data such as age, marital status, and income. Other factors include behavioral data such as tendency to purchase a particular product or service.

A common shared constraint of existing consumer behavior segmentation schemas for some applications is that they are difficult or unable to be applied to segment secondary or alternative data sets. They are restricted in some circumstances to use only in applications where there is access to the original base data used in defining the schema. For example, household level segmentation schemas defined on a base set of household characteristics can only be used to segment datasets for some applications with the same exact set of base characteristics. The same is true of geographic systems such as block level or ZIP+4 level, since they require base level geographic data inputs as defined in their original schema. This limits the usability of consumer segmentation for many applications as the development of distinct and separate schemas are required for applications that do not share the exact same base data.

Within market segmentation there may also be a distinct need to have the most specific information available connected to the consumer. This need may drive the use household-level and even person-level information. However, making effective use of individual data may be limited by the ability to code this information onto the consumer. An accurate name and address may be required to append household or person level information and this should be reliably matched into a file with the household level data for at least some applications. Providing name and address information may cause issues regarding privacy and confidentiality in the transmission, management, and processing of the data. Matching at the person and household level may produce several additional complicating factors. First, there may be challenges in resolving the name itself. These issues may derive from ambiguities in the way the name is spelled and presented. Second, there may also be the problem of establishing a stable base which may be critical in certain circumstance such as when using the appended data for market segmentation.

The “base” may be defined as the marketing term which refers to the count of all persons and/or households within a geographic area who might be able to buy or use a specific product or service. Within market segmentation it may refer to the exact counts of households within each of the market segments for a given geographic area. In many respects the “base” in market segmentation is very similar to the statistical sampling concept of a “sample frame”. The important distinction is that in sampling, the sample frame is known and used as the source for drawing a sample from the sample frame. This is reversed in market segmentation where typically the name and address file is known (a “sample”) and this “sample” is used to infer the larger “sample frame” or “base”. For example, a car dealer could have the names and addresses of recent new car buyers. This list could be used to determine the base for households that purchased a car at dealer X. The base could be determined to be all households living within 15 miles of car dealer X. As a result those households which live further than 15 miles from the dealer and bought a car would be removed from the purchaser set to keep the two concepts consistent.

Although “list services” vendors may be able to address many of the name resolution issues, there may be a persistent issue regarding the “base”. This derives from the fact that lists may have biases in terms of their demographic characteristics. Further, due to the nature of the business, they may have a tendency to accumulate as many names as possible: erring on the side of too many names (either having records for people who may no longer live there or misidentifying other members of the household as separate householders).

A final complication may arise from the need to code as many records as possible with market segment codes. Since many records may have incomplete name and address characteristics, there is often a requirement to provide alternate coding at a “higher” geographic level (usually ZIP+4 or Census block group and extended in this patent application to include ZIP+6). This may be referred to as using a “fill-in” assignment. While a method to provide consistent coding at each level has been solved by a previous patent, the development of an appropriate base to use in the ZIP+6 level has not been previously resolved.

The problem of extending to the ZIP+6 level is very subtle and can be represented by a simple example. The basic way segmentation may be used is to compare the market penetrations of a product across the market segments. An example is presented in Table 1 that follows.

TABLE 1

| | Segment | | | |
|---|---|---|---|---|
| | 1 | 2 | 3 | Total |
| Household | | | | |
| Count of | 2 | 2 | 4 | 8 |
| Users | | | | |
| Base | 10 | 15 | 15 | 40 |
| Penetration | 20% | 13% | 27% | 20% |
| ZIP + 4 | | | | |
| Count of | 1 | 1 | 2 | 4 |
| Users | | | | |
| Base | 10 | 20 | 10 | 40 |
| Penetration | 10% | 5% | 20% | 10% |
| Combined | | | | |
| Count of | 3 | 3 | 6 | 12 |
| Users | | | | |
| Base | 10 | 16.7 | 13.3 | 40 |
| Penetration | 30% | 18% | 45% | 30% |

The example shows a simple market area containing 40 households and divided into three market segments. A survey finds that 12 households use a specific product. Eight of the households can be identified uniquely by name and address and as a result can be assigned into a market segment using household data. However, owing to coding or other problems, four households can only be identified as being in a specific ZIP+4 and not to a unique household. These households are assigned into market segments on the basis of their ZIP+4 aggregated characteristics.

As shown in Table 1, the Count of Users indicate the known users of a certain product. Note that under the Total column there are 8 total users at the household level and four total users at the ZIP+4 level. Also, under the Total column, there is a total base shown of 40 for both the household and ZIP+4 levels.

The problem is that while it may be very sensible to say that 12 out of 40 households use the product, it is less clear what the correct product usage rate should be by market segment. This is because the base counts for the household market segments differ from those for ZIP+4 market segments. The estimate for segment 1 is trivial since the number of households or the Base in segment 1 at the household level matches the number of households in ZIP+4's assigned to segment 1. The complication arises from the fact that the Base number of households (e.g., 15) assigned to segment 2 using household characteristics is not the same as the Base number of households (e.g., 20) living in ZIP+4's which have been assigned to segment 2 using the characteristics of the ZIP+4. Similarly, the Base numbers at the segment 3 do not match.

In general this may always be the case. Simply apportioning the base counts by the fraction of households assigned at each level may ignore the very real fact that the reasons a record may be coded at the household level verses the ZIP+4 level or some other geographic level may not be random. These effects may represent biases in list compilation and other non-random influences which may vary both locally and globally. Thus, there may be no simple direct approach for correcting this issue at a low level, such as the ZIP+6 level.

### BRIEF DESCRIPTION OF THE DRAWINGS

In the following, the disclosed embodiments of the invention will be explained in further detail with reference to the drawings, in which:

FIG. 1 is a flow chart illustrating a generalized population segmentation developmental method according to a disclosed embodiment of the invention;

FIG. 2 is a generalized flow chart illustrating a population segmentation application method according to a disclosed embodiment of the invention;

FIG. 3 is a flow chart of a specific example of a population segmentation developmental method;

FIGS. 4 and 5 are flow charts of a specific example of a classification tree, illustrating a downshift in resolution;

FIGS. 6 and 7 are flow charts of another specific example of a classification tree, illustrating a level upshift in resolution;

FIG. 8 is a block diagram of a population segmentation developmental system according to a disclosed embodiment of the invention; and

FIG. 9 is a block diagram of a population segmentation application system according to a disclosed embodiment of the invention; and

FIGS. 10-12 are flow charts of a segmentation application method according to a disclosed embodiment of the invention.

### DESCRIPTION OF CERTAIN EMBODIMENTS OF THE INVENTION

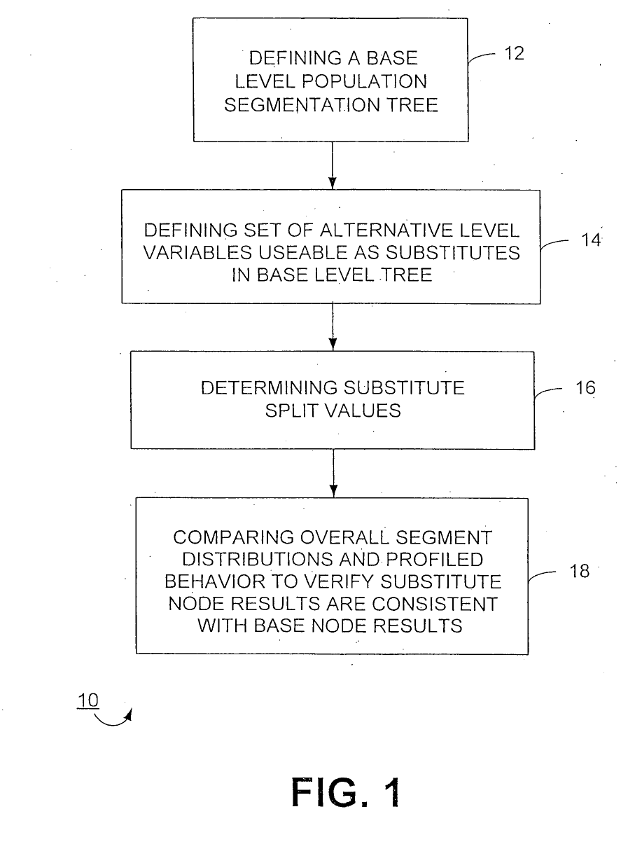

Referring now to the drawings and, more particularly, to FIG. 1 thereof, there is shown a developmental method, which is generally indicated at 10 and which is undertaken according to an embodiment of the invention. The method 10 generally comprises the defining of a base level population segmentation tree as indicated at box 12. The base level for the tree may be the household level. Such a tree method is disclosed in co-pending U.S. Patent Application, entitled “HOUSEHOLD LEVEL SEGMENTATION METHOD AND SYSTEM” and assigned application Ser. No. 09/872,457 filed Jun. 1, 2001, the application being incorporated herein by reference as if fully set forth in its entirety.

It is indicated in box 14, a set of alternate level variables are defined to be usable as substitutes in the base level tree as hereinafter described in greater detail. As indicated at box 16, the substitute split values are determined for each node of the base level tree, as further explained in greater detail hereinafter. Once the substitute split values are determined, as indicated at box 18, a verification can be undertaken by comparing the overall segment distributions and profiled behavior to ensure the consistency of the results whether using the base level or an alternate other level. In this regard, the substitute node results are compared with the base node results to determine a consistency for verification purposes.

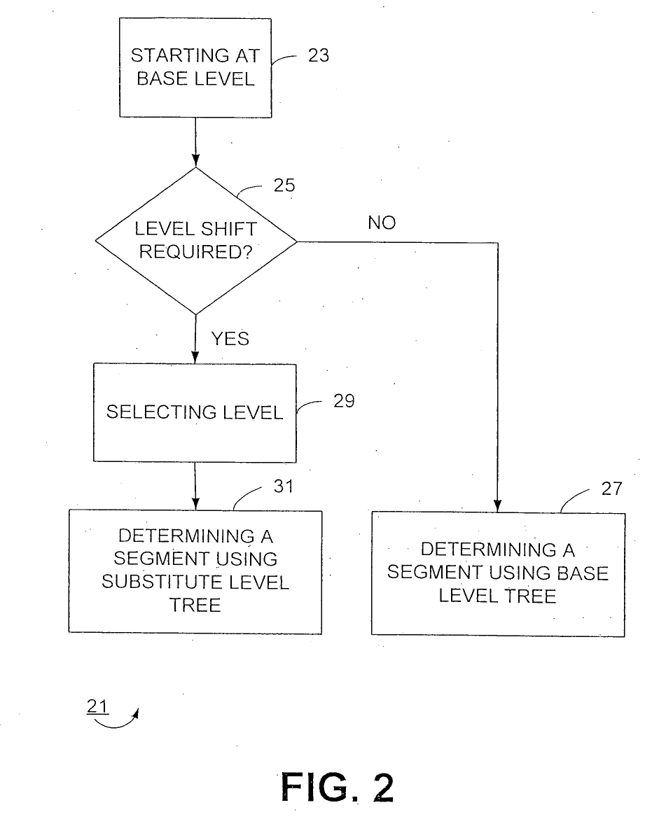

Once the alternate level variables are defined and the split values are determined, as shown in FIG. 2, an application method, which is generally shown at 21 and which is undertaken according to an embodiment of the invention. The method 21 starts at the base level as indicated at box 23, and then a determination is made as to whether or not a level shift is required at box 25. If a level shift is not required, then, as indicated at box 27, a segment is determined using the base level tree such as indicated in the aforementioned U.S. Patent Application incorporated herein by reference.

If a level shift is required, then, as indicated at box 29, a level is selected, and a segment is determined using the substitute level tree as indicated at box 31.

For purposes of the examples disclosed herein, the following table describes the list of typical segmentation levels:

| LEVELS | NO. OF HOUSEHOLDS | |
|---|---|---|
| HOUSEHOLD | 1 | HOUSEHOLD |
| ZIP + 4 | 5 | HOUSEHOLDS |
| BLOCK GROUP | 350 | HOUSEHOLDS |
| TRACT | 1657 | HOUSEHOLDS |
| ZIP CODE | 3657 | HOUSEHOLDS |

According to the Method 21, a level shift can occur either upwardly or downwardly. A downward shift would be from a higher level such as the Household level, to a lower level such as the Tract Group level. An upshift occurs from a lower level, such as the ZIP Code to an upper level such as the ZIP+4 level. In this regard, the highest level is the Household level, since the variables such as income and age are collected for each individual household. As the table indicates, the bottom four levels are geographic levels and each contains a given number of households. Thus, the geographic levels are less precise and are, thus, at a lower level than the Household level.

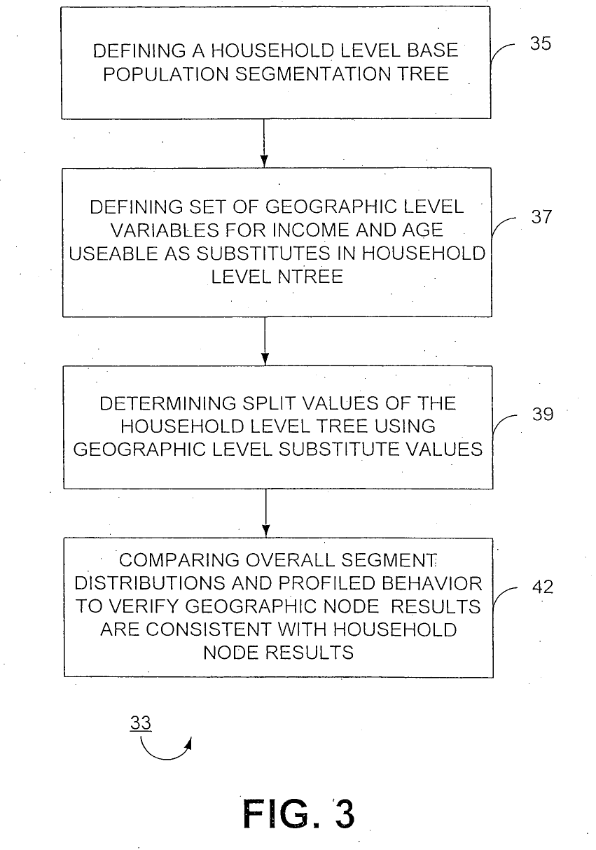

Referring now to a more specific example, reference may be made to FIG. 3. In FIG. 3, there is shown an example of a developmental method 33, which starts with the defining a Household base level population segmentation tree as generally indicated at 35. A set of geographic level variables are defined for income and age usable as substitutes in the Household level tree as indicated at box 37. The split values of the Household level tree are determined using geographic level substitute values as indicated at box 39.

Once these definitions and determinations are made, as indicated at box 42, the overall segment distributions and profiled behavior are compared to verify the results as being consistent. In this regard, geographic node results are compared with household node results to determine whether or not they are consistent. If so, then the substitute values are deemed to be consistent with the base level values.

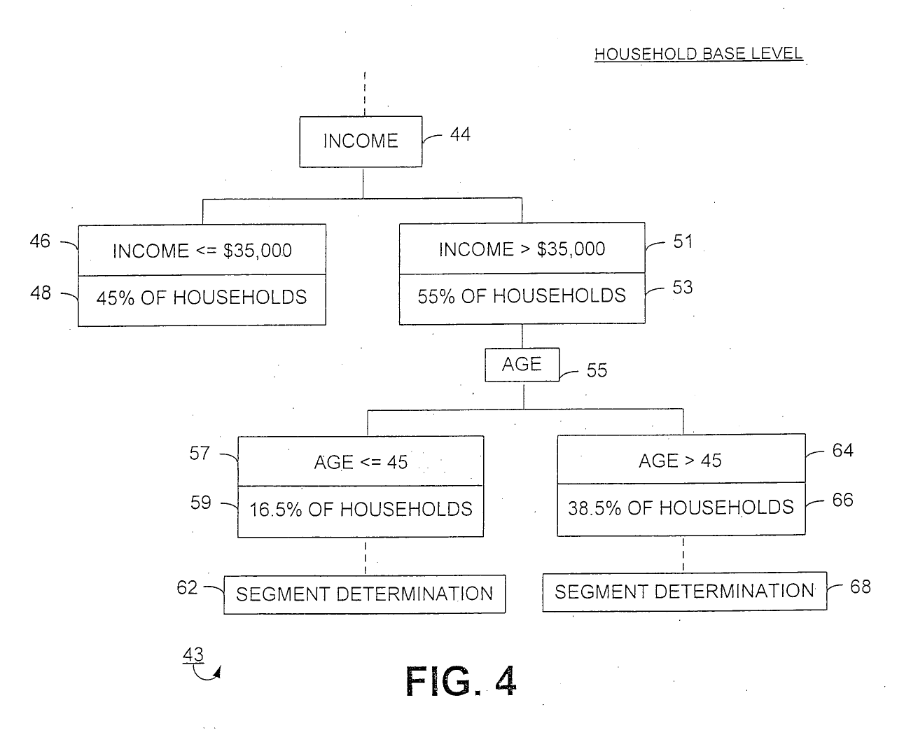

As shown in FIG. 4, an application method generally indicated at 43 is illustrated. The method 43 is a household base level tree system. At an income node of 44, a split is determined in the income of the population. As indicated at box 46, an income of less than or equal to $35,000 is determined to be 45% of the households that indicated at box 48. As indicated at box 51, an income of greater than $35,000 produces a split of 55% of the households as indicated at box 53.

Subsequent nodes such as an age node is then determined. Under the income of greater than $35,000, an age node 55 has a split at box 57 of an age equal to or less than 45 years of age, resulting in a split of 16.5% of the households as indicated at box 59. This then may result ultimately in a segment determination as indicated at box 62.

At an age of greater than 45 as indicated at box 64, this results in 38.5% of the households as indicated at box 66 for the household base level tree. This would then ultimately result in a segment determination at box 68.

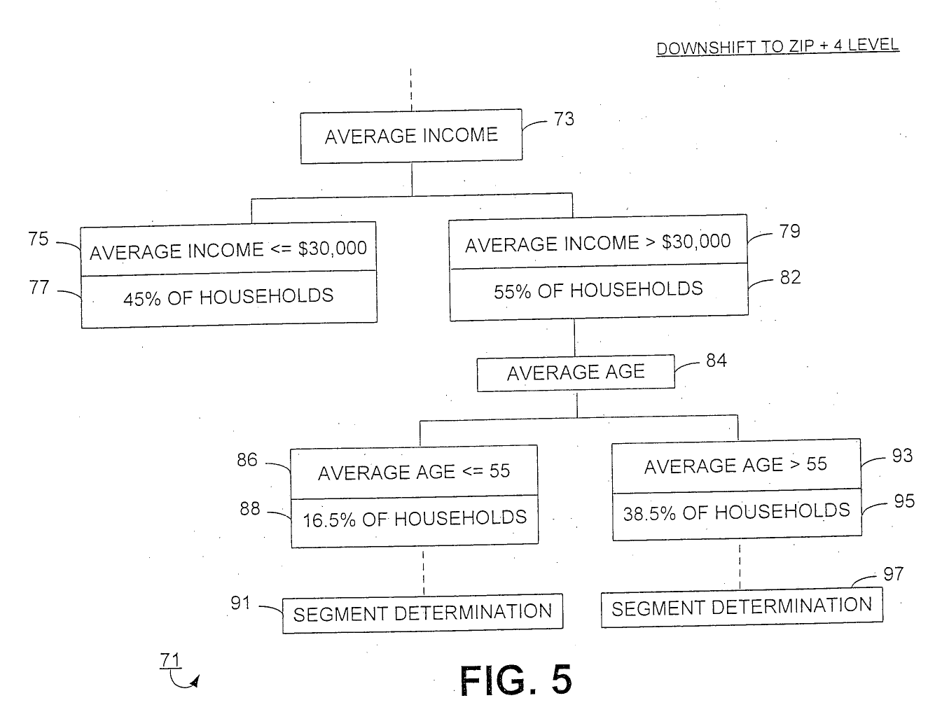

Considering now a downshift to a lower level in the geographic level grouping as indicated in FIG. 5, a downshift from a household base level to a ZIP+4 level will now be considered. At an average income node such as indicated at box 73, a split is determined in the tree using the substitute variables for the average income of equal to or less than $30,000 as indicated at box 75, resulting in 45% of the households as indicated at box 77 for a ZIP+4 segmentation level. It is noted that the same split value of $30,000 is used consistent with the base level as shown in FIG. 4.

At the split for an average income of greater than $30,000 as indicated at box 79, it is determined that 55% of the households for the ZIP+4 level is indicated at box 82.

The average age nodes are used at the same split values as used for the base level. For example, under the average income greater than $30,000, an average age node 84 is split at an average age of less than or equal to 55 as indicated at box 86 to result in 16.5% of the households for the ZIP+4 level as indicated at box 88. This split would then ultimately result in a segment determination as indicated at box 91. Similarly, at the average age of greater than 55 as indicated at box 93, 38.5% of the households are greater than 55 years of age for the ZIP+4 level as indicated at box 95. This would then ultimately result in a segment determination as indicated at box 97.

Thus, the same split in the number of households for both income and age are used for all five levels. Thus, in the household base level, the base level tree results in one of a given number of segments (such, for example, as 66 segments). Additionally, each one of the geographic lower levels will also result in one of the same given number of segments, such, for example, as 66 segments.

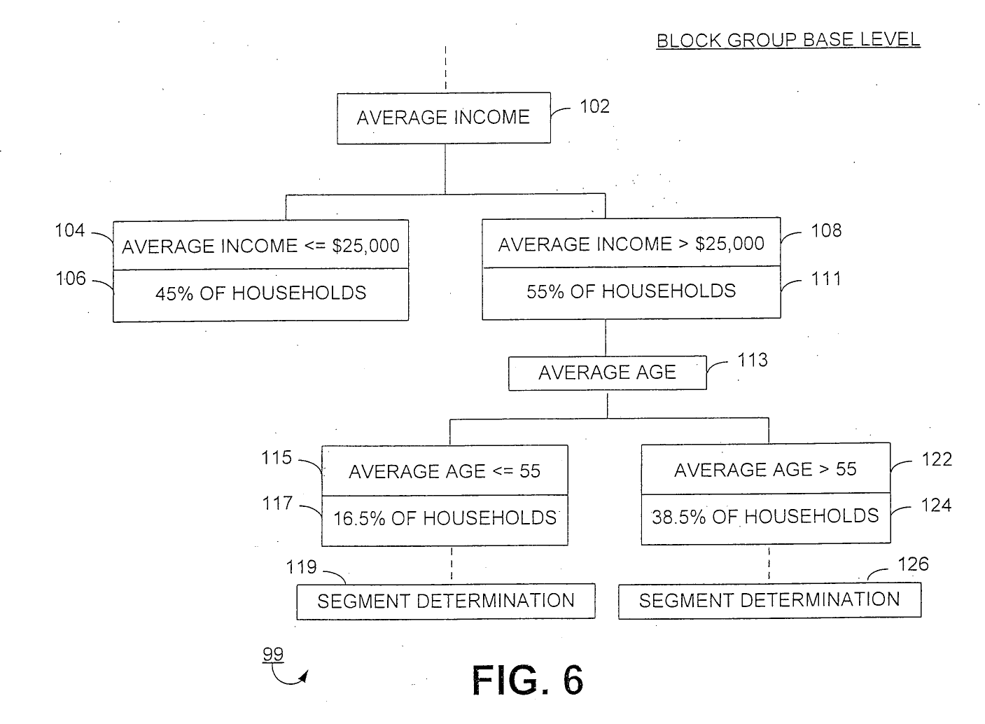

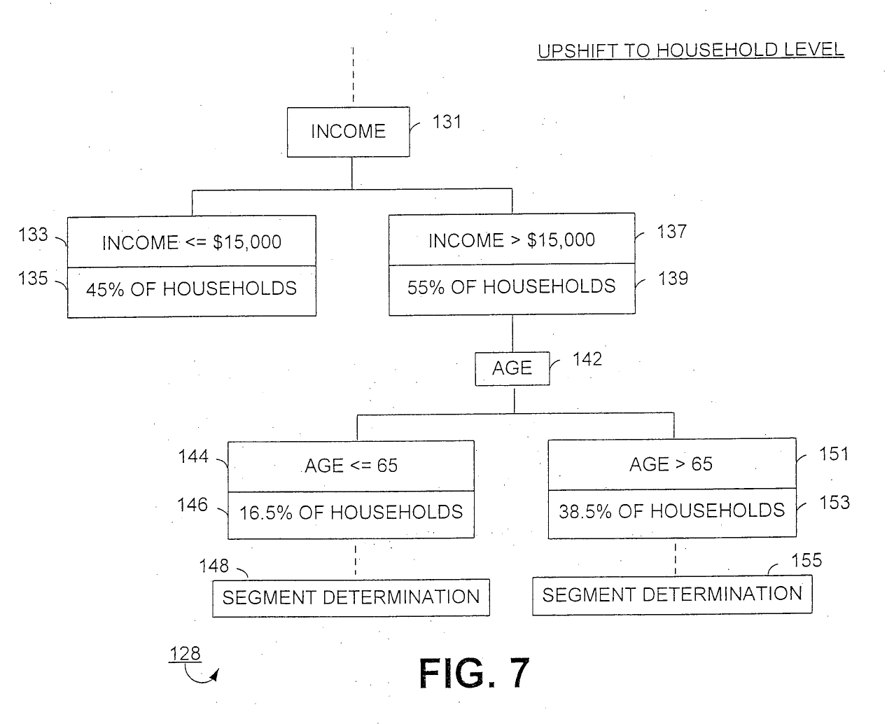

Referring now to FIGS. 6 and 7, an upshift between segmentation levels will now be described. As shown in FIG. 6, a method 99 is shown for a block group base level. At an average income node as indicated at box 102, a split of income is determined. As indicated at box 104, an average income of less than or equal to $25,000 per year as indicated at box 104, results in 45% of the households in the block group as indicated at box 106.

As indicated at box 108, an average income of greater than $25,000 is determined for 55% of the households of the block group base level as indicated at box 111.

An average age split is determined as indicated at box 113 for the average income greater than $25,000. As indicated at box 115, an average age of equal to or greater than 55 results in 16.5% of the households at box 117. To ultimately cause a segment determination at box 119. Similarly, at box 122, an average age of greater than 55 results in 38.5% of the households of the block group as indicated at box 124, resulting ultimately in a segment determination at box 126.

As shown in FIG. 7, an upshift to a household level from the block group base level, can take place at an income node as indicated at box 131. It is determined that at box 133 an income of less than or equal to $15,000 is the income for 45% of the households at the household level as indicated at box 135. An income of greater than $15,000 as indicated at box 137 is the income for 55% of the households at the base household level as indicated at box 139.

At an age node such as indicated at box 142 for the incomes greater than $15,000, at an age of less than or equal to 65 years of age as indicated at box 144, there are 16.5% of the households having persons at that age level as indicated at box 146. This results ultimately in a segment determination at box 148.

At an age greater than 65, as indicated at box 151, 38.5% of the households have people under that age for the household level as indicated at box 153. This results ultimately in a segment determination as indicated at box 155.

It should be noted that in both the upshift and downshift examples, the average income and average ages are used at the lower geographical levels. Also, by using the method and system of the embodiments of the invention, the same number of segments are used for both the base level and the substitute levels. For example, in a household level tree, there may be a segmentation of 1 of 66 segments. Each one of these substitute lower levels will also result in one of 66 segments.

The disclosed method and system may be developed at the household level. The system schema disclosed herein, uniquely classifies households into 1 of 66 segments. The segments are designed so that the households assigned into a specific segment will be expected to share common consumer and demographic behaviors and characteristics. Assignment into a segment is done using characteristics that are associated with the household such as age, income, presence of children, type of neighborhood in which the household resides. A patent is pending for the methodology used to develop the household schema.

The disclosed system and method constitute a comprehensive solution as the system extends beyond its base household level and is made usable for geographic assignment of segment codes. Segmentation schemas according to the disclosed embodiments of the invention provide the same set of segment assignments at both the household and geographic levels. In applications requiring both levels, household and geographic, two completely different systems are usually required. One system that uses household level data only with one set of segment definitions, and another system that uses geodemographic data only with its own unique set of segments.

The disclosed embodiments of the present invention provide a segmentation system for classifying a population into market segments that can be used to describe, target and measure consumers by their demand for and use of particular products and services. The segments are optimized to provide high-lift profiles for the evaluation profiles.

The disclosed process takes a base household level schema and uses that schema to assign the same segment codes using an alternative geodemographic data set. The basic process, referred to as “upshift/downshift,” can also be applied in other techniques as well. For example, the method and apparatus of the embodiments of the invention can be used to transfer between a variety of levels such as a transfer from a geographic system to households, from a household system to individuals, or from a household system to another household data set that does not have the exact same variables as used in the original schema.

Having the same set of segments at all levels, household and geographic, greatly simplifies the use of segmentation as well as reducing the support and maintenance requirements for segmentation system providers. Simplification in use comes from not being forced into either household or geodemographic systems. Now companies would have access to a unified system that can be applied at whatever level is reasonable for the given application. For providers of segmentation systems, it means not having to support and maintain a suite of different segmentation systems tailored to various levels, they now only have to support one system across all levels. This allows for a focusing of resources with a potential reduction in costs.

The process uses characteristics in an alternative data set to uniquely assign segments from the base schema to records in the alternative data set. The assignments must be done in such a way so that if a file is coded using the base system and compared with the codes assigned using the alternative data set, general predictions of behavior and overall descriptive statistics will be the same. That is, using the base or alternative system for analysis will generate the same general conclusions. The only difference may be in the clarity or precision of the analysis.

In the preferred embodiment of the invention, the base is the household level schema, and the alternative is a geographic version. The system can shift down from the household level schema to lower geographic levels. This shift is referred to as a down shift, because the move from the household level to a geographic level results in a lower level of precision.

The method starts with the base node table for a tree based segmentation system. The base system is the system for which an equivalent system at a different level is to be developed. For example, the base system could be at the household level and the alternative system the ZIP+4 versions. Define a set of variables for the alternative level that map into those required for the base system. This requires creation of a set of variables for the alternative level that can be used as substitutes in the node table for the base level schema. Continuing the example, this would require creation of ZIP+4 level measures for income, age, presence of children to use as substitutes for household income, age, and presence of children in the household level node table.

Using the substitute variables, rework the split values in the base node table so that each split the percent of households on each side of the split is maintained. For example, assume that the base node table had an income split at $35,000 with 45% of the households having income less than or equal to $35,000 and 55% having income greater than $35,000. For the alternative system, this split would be set using the ZIP+4 income so that 45% of the households across all ZIP+4s have ZIP+4 level income less than or equal to the new split value and 55% would be in ZIP+4s with income greater than the split. At the ZIP+4 level, this new split could be a value like $30,000. Verify that the node table created for the alternative geography creates results which are consistent with the base node table. This is done by comparing overall segment distributions and profiled behavior.

It is assumed that the base system can be defined using a node table or tree structure. Statistical routines that create these types of systems are often referred to as Classification Trees, Decision Trees, Divisive Partitioning, or CART. The common thread is these routines create rules which are mutually exclusive and exhaustive for classification of data. The “upshift/downshift” methodology can be applied to any set of rules that classify data in this manner. They also work in any direction. A higher level system such as a household level could be pushed down to a lower or smaller level such as a geographic level, as well as lower level systems pushed up to larger or higher levels such as to the household level. Thus, the name “upshift/downshift.”

As an example of a downshift to a lower level, assume that a base schema with three segments has been defined using household level age and income. The node table for this base schema follows:

| Split | Split | | | | | | |
|---|---|---|---|---|---|---|---|
| number | Variable | Value | Left Branch | Right Branch | % Left | % Right | % at Split |
| 1 | Income | $35,000 | 2 | 3 | 45% | 55% | 100% |
| 2 | Terminal | | | | | | 45% |
| 3 | Age | 45 | 4 | 5 | 30% | 70% | 55% |
| 4 | Terminal | | | | | | 16.5% |
| 5 | Terminal | | | | | | 38.5% |

The tree structure for this schema is shown in FIG. 4.

In order to illustrate an example of the downshift to another level, an alternative ZIP+4 level schema may be developed according to an embodiment of the invention. In the ZIP+4 level alternative data set, substitute variables are created for income and age. Logical choices may be the average income and average age for households in each ZIP+4 level. Each ZIP+4 level must also have a household count. The split values in the base schema are calculated using the ZIP+4 level substitute values so that the reported household percents in the base schema are maintained.

The resulting alternative ZIP+4 node table for this may be:

| Split | Split | | | | | | |
|---|---|---|---|---|---|---|---|
| number | Variable | Value | Left Branch | Right Branch | % Left | % Right | % at Split |
| 1 | Average Income | $30,000 | 2 | 3 | 45% | 55% | 100% |
| 2 | Terminal | | | | | | 45% |
| 3 | Average Age | 55 | 4 | 5 | 30% | 70% | 55% |
| 4 | Terminal | | | | | | 16.5% |
| 5 | Terminal | | | | | | 38.5% |

The tree structure for this alternative schema is shown in FIG. 5.

Considering now an upshift to a higher level, such as from a geographic level to the household level, assume for example, a base schema with 3 segments has been defined using block group level average age and average income. The node table for this base schema follows:

| Split | Split | | | | | | |
|---|---|---|---|---|---|---|---|
| number | Variable | Value | Left Branch | Right Branch | % Left | % Right | % at Split |
| 1 | Average Income | $25,000 | 2 | 3 | 45% | 55% | 100% |
| 2 | Terminal | | | | | | 45% |
| 3 | Average Age | 55 | 4 | 5 | 30% | 70% | 55% |
| 4 | Terminal | | | | | | 16.5% |
| 5 | Terminal | | | | | | 38.5% |

The tree structure for this schema is shown in FIG. 6.

An alternative level schema would be developed by the level alternative data set, substitute variables created for average income and average age. Logical choices may be the household income and household age. Calculate the split values in the base schema using the household level substitute values so that the reported household percents in the base schema are maintained. The resulting alternative ZIP+4 node table for this may be:

| Split | Split | | | | | | |
|---|---|---|---|---|---|---|---|
| number | Variable | Value | Left Branch | Right Branch | % Left | % Right | % at Split |
| 1 | Income | $15,000 | 2 | 3 | 45% | 55% | 100% |
| 2 | Terminal | | | | | | 45% |
| 3 | Age | 65 | 4 | 5 | 30% | 70% | 55% |
| 4 | Terminal | | | | | | 16.5% |
| 5 | Terminal | | | | | | 38.5% |

The tree structure for this alternative schema is shown in FIG. 7.

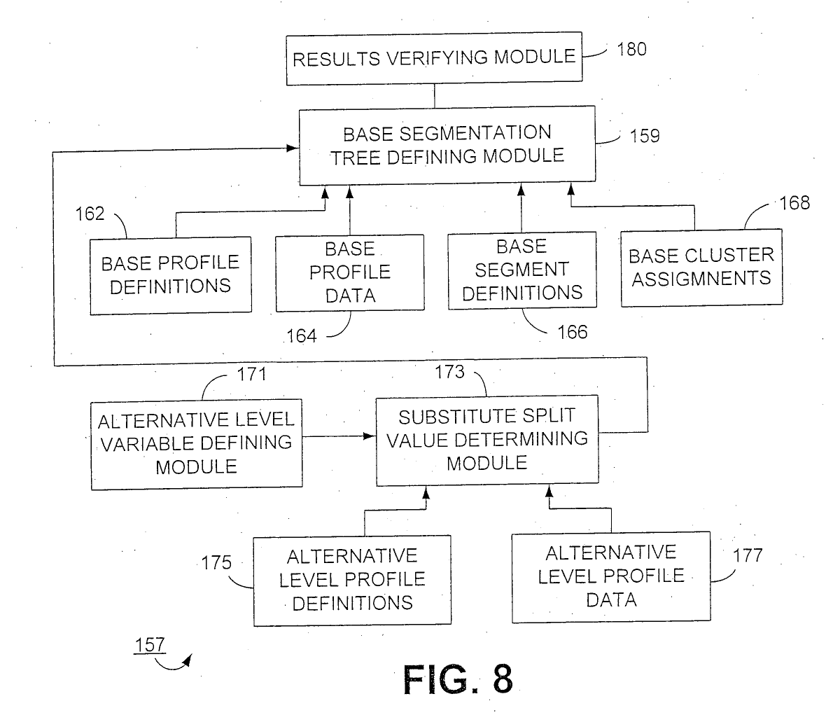

Referring now to FIG. 8, there is shown a population segmentation developmental system 157 used to execute the method of FIG. 1, in accordance with an embodiment of the invention. The system 157 includes a base segmentation tree defining module 159 which receives information from a base profile definitions database 162, a base profile data 164, a base segment definitions database 166 and a base cluster assignments database 168 to facilitate the defining of the base segmentation tree. This system is more fully and accurately described in connection with the aforementioned U.S. patent application incorporated herein by reference. It is to be understood that other different types and kinds of segmentation tree defining modules may be employed as will become apparent to those skilled in the art.

In order to facilitate the implementation of an alternate level segmentation tree using the same base segments, an alternative level variable defining module 171 communicates with a substitute split value determining module 173. The module 173 communicates with and obtains information from alternative level profile definitions database 175 and alternative level profile data 177 in accordance with the method of FIG. 1.

The results verifying module 180 compares the results of the base segmentation tree with the results obtained from the segmentation tree using alternative level variables provided by the module 173.

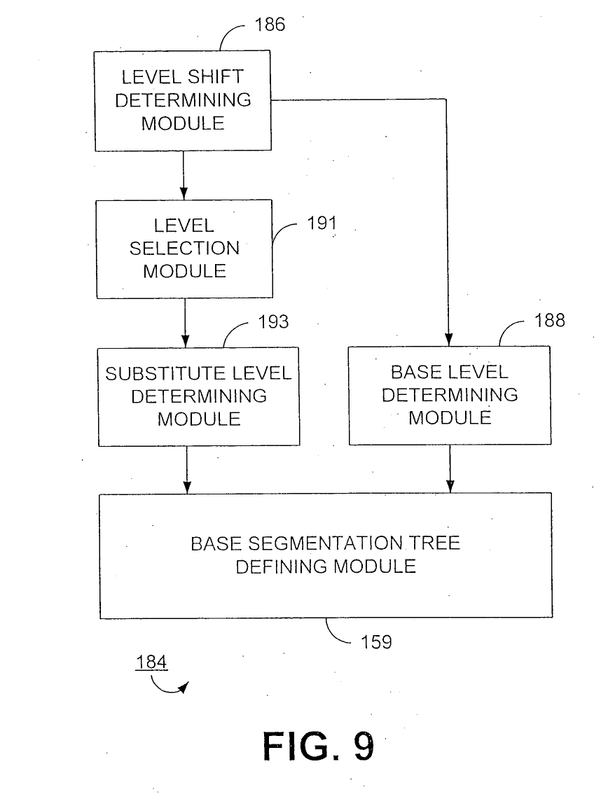

Referring now to FIG. 9, there is shown a population segmentation application system 184, which is useful in executing the method of FIG. 2, and which is constructed in accordance with an embodiment of the invention. The system 184 includes a level shift determining module 186 to facilitate making the determination as to whether or not a level shift is required. The module 186 activates a base level determining module 188 when it is determined that a level shift is not to be executed. The module 188 then communicates with the base segmentation tree defining module 159 to enable it to determine the base segmentation.

Alternatively, the module 186 communicates with a level selection module 191 when it is determined that a level shift is required. A substitute level determining module 193 communicates with the module 191 to provide the necessary substitute variables to the base segmentation tree defining module 159, which in turn provides the segmentation based upon the substitute variables in accordance with the method of FIG. 2.

Another embodiment of this invention develops a method to associate a stable demographic segment code using a ZIP+6 code as the identifier and a procedure to create a stable “base” for the market segmentation system that accommodates the ambiguities of multi-level coding (for example household verses ZIP+4 assignments). Further the method can be generalized to handle more complex scenarios where segment assignments from many different levels of assignment can be combined to insure the highest coding rate using the most accurate information available.

The method makes use of two basic Census concepts: housing unit and household. A housing unit is most typically a house or apartment but can include mobile homes, a group of rooms or even a tent or group quarters. For these purposes, housing units will comprise unique addresses. A housing unit can be either occupied, in which case it is considered a household or un-occupied in which case it is vacant.

The method manages the information content available to create a more complete universe of households than currently exists from list data sources. The available information includes data which represents actual households where demographic characteristics exist that can be used for developing segments at a low level (such as household or ZIP+6). These data are represented by the name and address records with demographic and behavioral characteristics from list compilers. The statistical problem for using this as a source for defining a base is to remove duplicate household information and correct for compilation bias. Another available source of data provides addresses where no households exist (information from business information compilers). These data must be added and models developed to determine whether that they are indeed non-residential. There are also sets of data for which suspected residential addresses exist (list compilers that can share address only information and have no demographic or behavioral information available). Here models are developed to establish whether they are residential or commercial and if residential, whether they are occupied, vacant, and to which market segment they belong. Finally, there are sets of data at geographic levels (such as ZIP+4, Census block group, ZIP Code) with detailed information regarding the count of households and housing units. These data are used to identify locations where housing units and households should be present but are currently not represented.

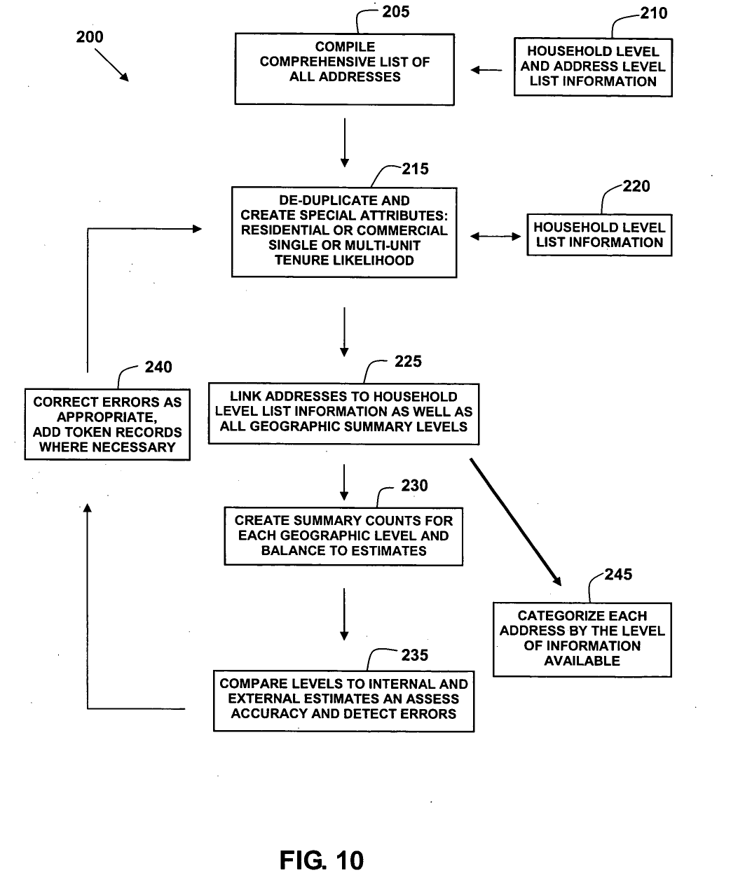

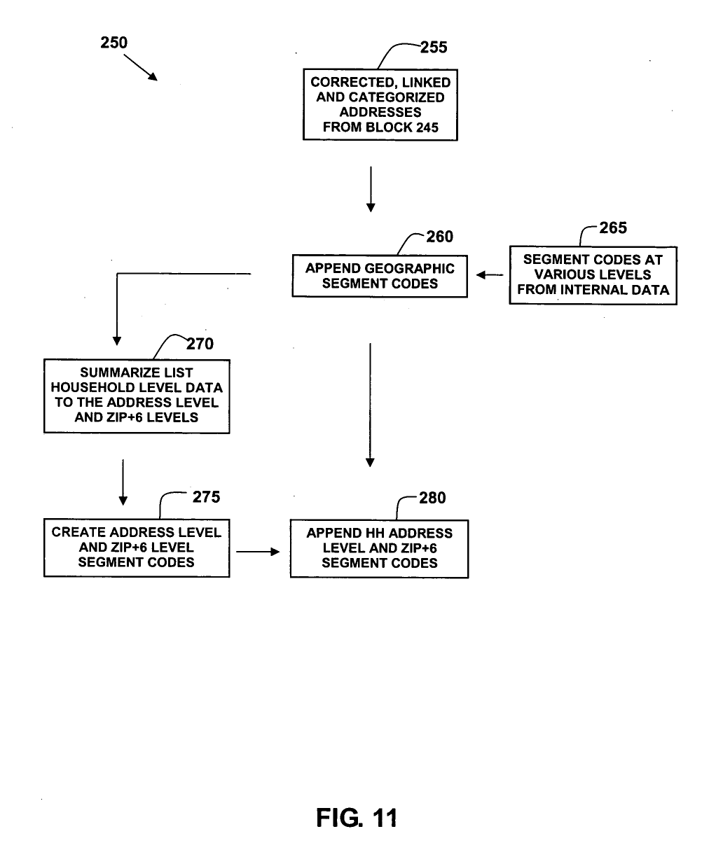

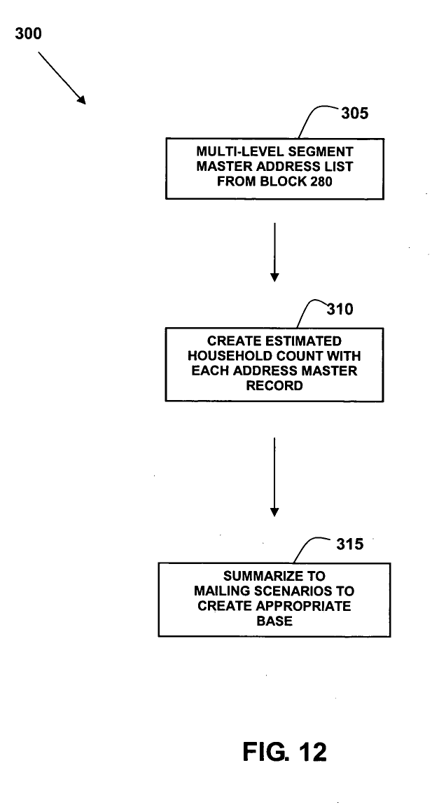

As shown in FIGS. 10-12, an application method, a ZIP+6 level system, is illustrated. The method includes creating a master address list in FIG. 10, creating segment codes in FIG. 11, and creating a multi-level coding base in FIG. 12.

Referring to FIG. 10, the method of creating the master address list generally indicated at 200 is illustrated. The creating the master address list begins with the acquisition of as many addresses as possible generating a compilation of a comprehensive list of addresses as shown in block 205. The addresses are compiled from many different sources (block 210) and include both residential and commercial addresses.

In block 215 the addresses are maintained and unduplicated using standard techniques and then connected to the household list demographics from block 220 to create a master address list. A number of rules are applied to the master address list to create important attributes such as age, income, home ownership, and presence of children. This step also provides a mechanism to differentiate commercial from residential addresses. The final list of residential addresses represents an approximation to the Census concept of housing units. Although commercial addresses are not used per se by the segmentation schemes, they must be maintained as many of the sources which provide data used in creating household estimates includes both commercial and residential addresses in their counts. By including the commercial addresses, these extraneous counts may be later removed. Similarly, rules are developed through statistical modeling to distinguish between single-unit and multi-unit addresses, categorize tenure (owner, renter), and create preliminary housing unit and household counts for each address present in a manner consistent with the Bureau of the Census definitions. These characteristics form the controls for insuring the accuracy of the master address list.

The master address list is then coded with other geographic identifiers (ZIP+6, ZIP+4, ZIP code, Census Block, Block Group, and Tract) in block 225 and summarized to each key geography (ZIP Code, ZIP+4, and Census Block Group) in block 230. At this point the summarized data in block 235 are compared to estimates of housing units and households from other sources by geographic level and unit to determine consistency. Under-counts and over-counts discovered in this comparison are handled in block 240. Where under-counts exist, token placeholder records are inserted in the master address list to correct the deficiencies. Over-counts are handled by re-examining the state of the housing unit (occupied or vacant) and/or its geographic assignment. Any changes are fed back into the master address list. The corrected master address list is then re-evaluated in terms of the key characteristics in block 215. These steps are repeated until a satisfactory level of overall accuracy is achieved.

Finally, each address or token address is categorized by the lowest level of information available (household, ZIP+6, ZIP+4, or Block Group) in block 245. Thus each address record is encoded with the lowest level of information that can be associated with that housing record and, if occupied, it's household. Through focusing on the use of unique household addresses the file does not allow list based information to be double counted and removes a substantial amount of compilation bias. An example of how the addresses might appear is given in Table 2.

TABLE 2

| | | | | | | | | | Res. | Single/ | | | | |
|---|---|---|---|---|---|---|---|---|---|---|---|---|---|---|
| | | | Apt | Apt | | | | | Or | Multi- | Housing | House- | | Seg. |
| Street | No. | Suffix | Prefix | No. | Block Group | ZIP | ZIP + 4 | ZIP + 6 | Com. | Unit | Units | holds | Level | Code |
| Needwood | 8111 | | Suite | 1 | 240317007111 | 20855 | 2266 | 1 | C | M | 0 | 0 | None | NA |
| Rd | | | | | | | | | | | | | | |
| Needwood | 8111 | | Apt | 101 | 240317007111 | 20855 | 2269 | 54 | R | M | 1 | 1 | HH | 1 |
| Rd | | | | | | | | | | | | | | |
| Needwood | 8111 | | Apt | 102 | 240317007111 | 20855 | 2269 | 55 | R | M | 1 | 1 | HH | 3 |
| Rd | | | | | | | | | | | | | | |
| Needwood | 8111 | | Apt | 103 | 240317007111 | 20855 | 2269 | 56 | R | M | 1 | 0 | HH | 2 |
| Rd | | | | | | | | | | | | | | |
| Needwood | 8111 | | Apt | 104 | 240317007111 | 20855 | 2269 | 57 | R | M | 1 | 0 | ZIP + 4 | 3 |
| Rd | | | | | | | | | | | | | | |
| Needwood | 8113 | A | | | 240317007111 | 20855 | 2270 | 13 | R | S | 1 | 1 | ZIP + 4 | 5 |
| Rd | | | | | | | | | | | | | | |
| Needwood | 8113 | B | | | 240317007111 | 20855 | 2270 | 13 | R | S | 1 | 1 | ZIP + 4 | 5 |
| Rd | | | | | | | | | | | | | | |

| | | | | | | | |
|---|---|---|---|---|---|---|---|
| {Place holder Record: | 240317007111 | 20855 | M | 24 | 15 | Block | 4 |
| estimated missing | | | | | | Group | |
| Block Group portion within ZIP} | | | | | | | |

Referring now to FIG. 11, the method of creating segment codes generally indicated at 250 is illustrated. The creation of the actual ZIP+6 level segment codes 250 proceeds using the master address list from FIG. 10 as shown in block 255. In block 260 the high level geographic (ZIP+4, Block Group) segment code assignments (block 265) are appended to the master address list. A summarized list is created by summarizing the master address list to the ZIP+6 level in block 270. Address level and ZIP+6 level segment codes are created in block 275. In cases where a single set of household data are present for a ZIP+6, the address receives the same segment code assignment as the household would. In cases where the multiple household records share the same ZIP+6 (this may occur either as a result of multiple individual records present on the list for that ZIP+6, multiple households sharing the same address, or the inclusion of incorrect multiple records) the characteristics are weight averaged and the ZIP+6 assignment is built on the averaged characteristics. These segment codes assignments are then placed on the master address file in block 280.

Referring now to FIG. 12, the method of creating a multi-level coding base generally indicated at 300 is illustrated. The creation of the multi-level coding base proceeds using the master address list from FIG. 11 as shown in block 305. In block 310 an estimated household count associated with each address is created. The household information for each address record, combined with the segmentation code from the master address file is then used to create the appropriate base for each analysis scenario in block 315. At this point the master address list represents a largely unbiased approximation of all households. In other words, the list includes a record for all households that any specific market segmentation application might encounter. This implies it will have a matching record for data coming in from a behavioral file that can be matched at each geographic level (household, ZIP+6, ZIP+4, ZIP Code, census block group). The process for creating a base for a specific application (that is a principal coding level, i.e. ZIP+6, and any fill-in levels employed, i.e. ZIP+4, block group, and ZIP Code) is to add up the counts in the master address list by the principal coding level as well as the allowed fill-in levels and summarize by market segment.

While particular embodiments of the present invention have been disclosed, it is to be understood that various different modifications and combinations are possible and are contemplated within the true spirit and scope of the appended claims. There is no intention, therefore, of limitations to the exact abstract or disclosure herein presented.

1. A method of market segmentation, comprising:
creating a master address list containing a plurality of residential addresses;
removing duplicate addresses in the master address list;
coding addresses in the master address list with additional geographic identifiers;
summarizing the addresses into at least one of the geographic identifiers;
comparing the summarized addresses to an estimate from another source; and
inserting token records in the master address list when under-counts are discovered in the comparison.

2. The method according to claim 1, further comprising creating preliminary housing unit and household counts for each address.

3. The method according to claim 2, wherein creating preliminary housing unit and household counts includes distinguishing between single-unit and multiple-unit addresses and categorizing tenure.

4. The method according to claim 2, whereby creating preliminary housing unit and household counts is accomplished in a manner consistent with Bureau of Census definitions.

5. The method according to claim 3, further comprising re-examining the geographic identifier assigned to the addresses and the distinguishing between single-unit and multiple-unit addresses when over-counts are discovered in the comparison.

6. The method according to claim 1, further comprising categorizing each address by the lowest geographical level of information available.

7. The method according to claim 1, further comprising appending high level segment code assignments to the master address list.

8. The method according to claim 7, further comprising creating a summarized list of the master address list summarized to the ZIP+6 level.

9. The method according to claim 8, further comprising assigning a first address with a first ZIP+6 code with a segment code associated with a household when only one set of household data exists for the first ZIP+6 code.

10. The method according to claim 8, further comprising assigning a second address with a second ZIP+6 code with an averaged segment code when multiple household records share the second ZIP+6 code.

11. The method according to claim 9, further comprising appending the segment code to the master address list.

12. The method according to claim 1, wherein the additional geographic identifiers include at least one of the group of ZIP+6, ZIP+4, ZIP code, Census Block Group, and tract.

13. A method of market segmentation, comprising:
creating a master address list coded with ZIP+6 geographic identifiers;
assigning a segment code to an address in the master address with a unique ZIP+6 code; and
appending the segment code to the master address list.

14. The method according to claim 13, wherein creating the master address list includes:
removing duplicate addresses in the master address list;
coding addresses in the master address list with additional geographic identifiers;
summarizing the addresses into at least on of the graphical identifiers; and
comparing the summarized addresses to an estimate from another source.

15. The method according to claim 14, further comprising inserting token records in the master address list when under-counts are discovered in the comparison.

16. The method according to claim 14, further comprising creating preliminary housing unit and household counts for each address.

17. The method according to claim 16, wherein creating preliminary housing unit and household counts includes distinguishing between single-unit and multiple-unit addresses.

18. The method according to claim 17, further comprising re-examining the geographic identifier assigned to the addresses and the distinguishing between single-unit and multiple-unit addresses when over-counts occur in the comparison.

19. The method according to claim 13, wherein assigning the segment code includes assigning a first address with a first ZIP+6 code with a segment code associated with a household when only one set of household data exists for the first ZIP+6 code.

20. The method according to claim 13, wherein assigning the segment code includes assigning a second address with a second ZIP+6 code with an averaged segment code when multiple household records share the second ZIP+6 code.

21. A system for market segmentation, comprising:
means for creating a master address list containing a plurality of residential addresses;
means for removing duplicate addresses in the master address list;
means for coding addresses in the master address list with additional geographic identifiers;
means for summarizing the addresses into at least one of the geographic identifiers;
means for comparing the summarized addresses to an estimate from another source; and
means for inserting token records in the master address list when under-counts are discovered in the comparison.

22. A system for market segmentation comprising:
means for creating a master address list coded with ZIP+6 geographic identifiers;
means for assigning a segment code to an address in the master address with a unique ZIP+6 code; and
means for appending the segment code to the master address list.
